(19) United States
(12) Patent Application Publication
(10) Pub. No.: US 2010/0233387 A1
(43) Pub. Date: Sep. 16, 2010

(54) INK FOR MAKING COLOR FILTER AND COLOR FILTER MADE THEREOF

(75) Inventors: HSIU-TING CHEN, Hsinchu (TW); CHING-YU CHOU, Hsinchu (TW)

Correspondence Address: Altis Law Group, Inc.;ATTN: Steven Reiss, 288 SOUTH MAYO AVENUE, CITY OF INDUSTRY, CA, 91789, US

(73) Assignee: ICF TECHNOLOGY LIMITED., Santa Clara, CA (US)

(21) Appl. No.: 12/402,760

(22) Filed: Mar. 12, 2009

(51) Int. Cl. G02F 1/1335; C08F 2/46; C08G 59/17; C08G 18/67; C08F 299/04; C08L 63/10; C08L 75/04; C08L 33/04

(52) U.S. Cl. 428/1.31; 522/1; 524/1; 522/100; 522/90; 522/104; 524/548; 524/555; 524/560

(57) ABSTRACT

An ink includes a solvent, a colorant, an initiator or dispersant, and a mixture of polymerizable high-viscosity component and polymerizable low-viscosity component polymerizable low-viscosity component.

### BACKGROUND

1. Technical Field

The present invention relates to color filters, particularly to an ink of color filters and a color filter using the ink.

2. Discussion of Related Art

A color filter is an important element of a liquid crystal display (LCD). The color filter is used for providing a primary color to each sub-pixel of the LCD. The color filter generally includes a glass substrate, a black matrix formed on a surface of the glass substrate, a color layer formed of red (R) color portions, green (G) color portions and blue (B) color portions, and a transparent electrically conductive layer covering the black matrix and the color layer. The black matrix defines a plurality of sub-pixels of the color filter. Every sub-pixel accommodates one color portion chosen from R, G, and B color portions.

The color filters are generally manufactured via a method called “pigment-dispersed method”. In the pigment-dispersed method, a spin coating process or slit coating process is generally used to print color resist on a substrate. After being exposed and developed, the color resist printed on the substrate becomes color areas. The color resist is a kind of resist with color pigment distributed uniformly therein.

A newer manufacturing method for color filters is an ink jet method. The ink jet method mainly includes a step of injecting an ink onto a transparent substrate by an ink jet head to deposit the ink on prescribed areas defined by a black matrix.

The ink jet method is thought to be more economic and environmental friendly. However, the smoothness of the color filter made by ink jet method is less than that of the color filter made by pigment-dispersed method.

The ink used in the ink jet method generally includes high viscosity monomers with high functionality, such as dipentaerythritol hexaacrylate, to enhance the solidifying speed, solidifying density and mechanical stiffness of the ink, and more specifically, to enhance curing character of the ink.

However, since the viscosity of the high viscosity monomers is too high, it is difficult to coat it uniformly, and its adhesion with the substrate will be also inferior.

What is needed, therefore, is a new ink for inkjet method used for a color filter.

### BRIEF DESCRIPTION OF THE DRAWINGS

Many aspects of the present color filter can be better understood with reference to the following drawings. The components in the drawings are not necessarily drawn to scale, the emphasis instead being placed upon clearly illustrating the principles of the present color filter and its related manufacturing method. Moreover, in the drawings, like reference numerals designate corresponding parts throughout the several views.

FIG. 1 is a cross-sectional view of a color filter in accordance with a second embodiment of the present invention; and

FIGS. 2 to 5 illustrate a manufacturing method of the color filter in accordance with the second embodiment of the present invention.

Corresponding reference characters indicate corresponding parts throughout the drawings. The exemplifications set out herein illustrate at least one preferred embodiment of the present color filter, in one form, and such exemplifications are not to be construed as limiting the scope of the invention in any manner.

### DETAILED DESCRIPTION OF THE INVENTION

Reference will now be made to the drawings to describe preferred embodiments of the present ink and the present color filter, in detail.

An ink in accordance with a first embodiment includes a solvent, a colorant, an initiator and/or dispersant, and a mixture of a polymerizable high-viscosity component and a polymerizable low-viscosity component. The polymerizable high-viscosity component includes high viscosity monomer or high viscosity oligomer. The polymerizable low-viscosity component includes low viscosity monomer or low viscosity oligomer.

The viscosity of the high viscosity monomer or high viscosity oligomer at 25 degrees Centigrade is from 1000 CPS to 5000000 CPS, preferably, from 10000 CPS to 2000000 CPS.

The viscosity of the low viscosity monomer or low viscosity oligomer at 25 degrees Centigrade is below 999 CPS, preferably from 10 CPS to 500 CPS, more preferably from 10 CPS to 250 CPS.

Preferably, molecular weight and chemical construction of the polymerizable high-viscosity component are different with that of the polymerizable low-viscosity component.

At least a solvent of the present ink is an organic solvent with a boiling point higher than 180 degrees Centigrade, preferably the boiling point of the solvent is between 190degrees Centigrade and 230degrees Centigrade. The vapor pressure of the solvent is smaller than 0.33 millimeters of mercury (mmHg) at 20 degrees Centigrade, preferably ranges from 0.00001 mmHg to 0.33 mmHg, and most preferably ranges from 0.01 mmHg to 0.33 mmHg. The above will be called as a main solvent or main solvents.

The total amount of the solvent in the ink ranges preferably from 15% to 95% by weight (wt), more preferably from 60% to 85% by weight. The total amount of the colorant in the ink ranges preferably from 0.1% to 30% by weight, more preferably from 2% to 15% by weight. The total amount of the initiator and/or dispersant in the ink ranges preferably from 0.1% to 10% by weight, more preferably from 0.1% to 10% by weight. The total amount of the mixture of the polymerizable high-viscosity component and the polymerizable low-viscosity component in the ink ranges preferably from 1% to 80% by weight, more preferably from 5% to 30% by weight. The total amount of the main solvent in the solvent is above 50% by weight. The total ratio of the polymerizable high-viscosity component in all of the polymerizable component mixture ranges from 50% to 99.9% by weight, preferably, from 50% to 80% by weight. The total ratio of the polymerizable low-viscosity component in all of the polymerizable component mixture ranges from 0.1% to 50% by weight, preferably, from 20% to 50% by weight.

To enhance the smoothness of the color filter, the surface tension of the ink ranges preferably from 22.5 dyne/cm to 35 dyne/cm, more preferably from 25 dyne/cm to 30 dyne/cm. Surfactant can be added to the ink to adjust the surface tension of the ink. The total amount of the surfactant in the ink is preferably less than 0.5% by weight.

Followings are detail description of the present ink.

The solvent with above-mentioned features includes ester, ether, ether acetate, alcohol, ketone, and their derivatives.

The solvent can be selected from but not limited to the group consisting of dipropylene glycol methyl ether, tripropylene glycol methyl ether, dipropylene glycol methyl ether acetate, dipropylene glycol n-propyl ether, propylene glycol n-propyl ether, dipropylene glycol n-butyl ether, tripropylene glycol n-butyl ether, glycol ether propylene glycol phenyl ether, diethylene glycol ethyl ether, diethylene glycol n-butyl ether, dietheylene glycol hexyl ether, ethylene glycol monobutyl ether acetate, ethylene glycol hexyl ether, triethylene glycol methyl ether, triethylene glycol ethyl ether, triethylene glycol n-butyl ether, ethylene glycol phenyl ether, trimethylnonanol, diethylene glycol monomethyl ether, hexylene glycol, and gamma butyrolactone. In addition, the above-mentioned solvent can further include other solvents in order to achieve the above feature. Low boiling point solvent also can be added into the solvent.

The colorant used in the present ink is not limited to a particular color. The colorant of the present ink is suitably selected according to the application purpose of the color filter, and may be a pigment, dye or natural coloring matter or the mixture of the above. The colorant preferably has a high color gamut and a high heat resistance. A pigment is generally used in the colorant due to its high permanence of color, and an organic pigment is particularly preferably used.

Illustrative examples of the organic pigment are compounds classified into a group of pigments according to color index (C.I.; The Society of Dyers and Colourists). Specifically, the organic pigment are compounds having the following color index numbers: C.I. Pigment Red 122, C.I. Pigment Red 177, C.I. Pigment Red 185, C.I. Pigment Red 202, C.I. Pigment Red 206, C.I. Pigment Red 207, C.I. Pigment Red 209, C.I. Pigment Red 224, C.I. Pigment Red 254, C.I. Pigment Red 264, C.I. Pigment Blue 15:3, C.I. Pigment Blue 15:4, C.I. Pigment Blue 15:6, C.I. Pigment Green 7, C.I. Pigment Green 36, C.I. Pigment Green 58, C.I. Pigment Yellow 74, C.I. Pigment Yellow 83, C.I. Pigment Yellow 110, C.I. Pigment Yellow 138, C.I. Pigment Yellow 139, C.I. Pigment Yellow 150, C.I. Pigment Yellow 151, C.I. Pigment Yellow 155, C.I. Pigment Yellow 180, C.I. Pigment Yellow 213, C.I. Pigment Violet 19, or C.I. Pigment Violet 23. In it to be understood that, other appropriate colorants may also be used in the present ink.

The initiator can be a photo initiator or a thermal initiator. The photo initiator is selected from the group consisting of 4,4-bis(dimethylamino)benzophenone, 4,4′-bis(diethylamino)benzophenone, 2-(4-methoxyphenyl)-4,6-bis(trichloromethyl)-1,3,5-triazine, and tris(trichloromethyl)-1,3,5-triazine. Photo initiators currently in use include IRGACURE® 819, IRGACURE® 369, IRGACURE® 2959, IRGACURE® 379, IRGACURE® 184, IRGACURE® 784, IRGACURE® 250, IRGACURE® 907, IRGACURE® 651, IRGACURE® OXE01, IRGACURE® OXE02, IRGACURE® 500, IRGACURE® 1800, IRGACURE® 1000, IRGACURE® 1700, DAROCURE® BP, DAROCURE® 1173 CGI 242, DAROCURE® 1173 CGI-552 (products of Ciba Specialty Chemicals, JP), Chivacure® TPO, Chivacure® TPO-L, Chivacure® 200, Chivacure® 107, Chivacure® 184, Chivacure® 284 (products of Double Bond Chemical IND., CO., LTD, TAIWAN), KAYACURE DETX-S, KAYACURE CTX, KAYACURE BMS, and KAYACURE BP-100 (products of Nippon Kayaku K.K., JP). The thermal initiator can be selected from the group consisting of benzoyl peroxide, azobisisobutyronitrile, di-t-butyl peroxide, tert-butyl peroxy benzoate, and cumene hydro peroxide.

The high viscosity monomer or high viscosity oligomer includes epoxy acrylate oligomers with at least two functionalities, urethane acrylate oligomers with at least two functionalities, polyester acrylate oligomers with at least two functionalities, acrylate oligomers with at least two functionalities, diacrylate monomers with ethoxylated bisphenol A group, acrylate monomers with at least five functionalities, or their derivatives.

Preferably, the high viscosity oligomer is selected from the group consisting of bisphenol A epoxy diacrylate, bisphenol A epoxy dimethacrylate, amine modified bisphenol A epoxy acrylate, fatty acid modified bisphenol A epoxy acrylate, novolac epoxy acrylate, aromatic urethane diacrylat, aromatic urethane triacrylate, aromatic urethane hexaacrylate, aliphatic urethane diacrylate, aliphatic urethane triacrylate, aliphatic urethane hexaacrylate, polyester diacrylate, polyester tetraacrylate, polyester hexaacrylate, fatty acid modified polyester hexaacrylate, chlorinated polyester acrylate, amine modified polyester acrylate, aliphatic diacrylate and acrylate with a vitrification point above 20 degrees Centigrade.

Preferably, the high viscosity monomer is selected from the group consisting of ethoxylated (2) bisphenol A diacrylate, ethoxylated (3) bisphenol A diacrylate, ethoxylated (2) bisphenol A dimethacrylate, dipentaerythritol pentaacrylate and dipentaerythritol hexaarylate.

The low viscosity monomer or low viscosity oligomer includes acrylate oligomers with a vitrification point below 20 degrees Centigrade, acrylate monomer with 1, 2, or 3 functionalities, methacrylate monomers or their derivatives.

Preferably, the low viscosity monomer is selected from the group consisting of acrylate monomer with 2 functionalities, acrylate monomer with 3 functionalities, methacrylate monomer with 3 functionalities, and acrylate monomer with 4 functionalities.

More preferably, the low viscosity monomer is selected from the group consisting of diethylene glycol diacrylate, triethylene glycol diacrylate, polyethylene glycol (200) diacrylate, polyethylene glycol (400) diacrylate, polyethylene glycol (600) diacrylate, 1,3-butylene glycol diacrylate, 1,4-butylene glycol diacrylate, 1,6-hexylene glycol diacrylate, diethylene glycol diacrylate, ethoxylated (3) bisphenol A diacrylate, ethoxylated (10) bisphenol A diacrylate, ethylene glycol dimethacrylate, diethylene glycol dimethacrylate, triethylene glycol dimethacrylate, polyethylene glycol (200) dimethacrylate, polyethylene glycol (400) dimethacrylate, polyethylene glycol (600) dimethacrylate, 1,3-butylene glycol dimethacrylate, 1,4-butylene glycol dimethacrylate, 1,6-hexylene glycol dimethacrylate, ethoxylated (6) bisphenol A dimethacrylate, ethoxylated (8) bisphenol A dimethacrylate, ethoxylated (10) bisphenol A dimethacrylate, new pentanediol dimethacrylate, trihydroxymethylpropyl triacrylate, ethoxylated (3) trihydroxymethylpropyl triacrylate, ethoxylated (20) trihydroxymethylpropyl triacrylate, pentaoxylated (3) trihydroxymethylpropyl triacrylate, pentaoxylated (6) trihydroxymethylpropyl triacrylate, pentaerythritol triacrylate and pentaerythritol tetraacrylate.

The oligomers or monomers mention above can also modified to include functional groups selected from the group consisting of hydroxyl group(—OH), hydrogencyanato(—HCN), amino group(—NH), isocyanato(—NCO), carboxy(—COOH), —SH, eposy group, benzene ring, amide group, ester, usethane, siloxane, sulfide, vinyl group, anhydride, urea resin, carbonic acid, phosphate ester and sulfone.

The ink can also includes other additive. The additive can be a surfactant, an anti-foaming agent/defoamer, a dispersant, or a resin. Preferably, the surfactant can be selected form the group consisting of fluorosurfactant, polymeric fluorosurfactant, siloxane surfactant, polymeric siloxane surfactant, polyoxyethylene surfactants and their derivatives.

Preferably, the anti foaming agent/defoamer can be selected form the group consisting of siloxane surfactant, polymeric siloxane surfactant, polyoxyethylene surfactants and their derivatives.

Preferably, the dispersant can be selected form the group consisting of acrylate type or modified acrylate type polymeric dispersant, urethane type or modified urethane type polymeric dispersant, ether type or modified ether type polymeric dispersant, and other structure of polymeric dispersant. In addition, the general commodity under the trade name of solsperse (Lubrizol Ltd.) can also be used as the dispersant.

The resin can be a polymer or a copolymer containing acrylate or methacrylate. The resin also can be polymerized by monomers. The monomers can be selected from but not limited to the group consisting of acrylic acid, methacrylic acid, acrylate, methacrylate, ethyl methylacrylate, hydroxyethyl methacrylate, hydroxypropyl methacrylate, n-butyl methacrylate, iso-butyl methacrylate, Iso-butyl methacrylate, n-dodecyl methacrylate;cauryl methacrylate, n-dodecyl methacrylate;cauryl methacrylate and their derivatives.

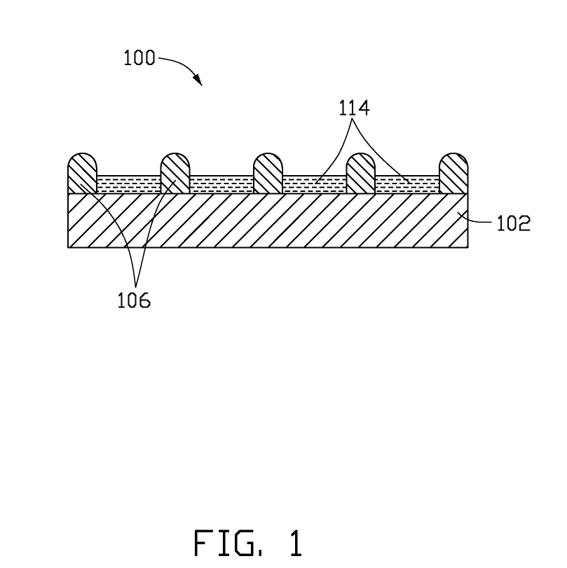

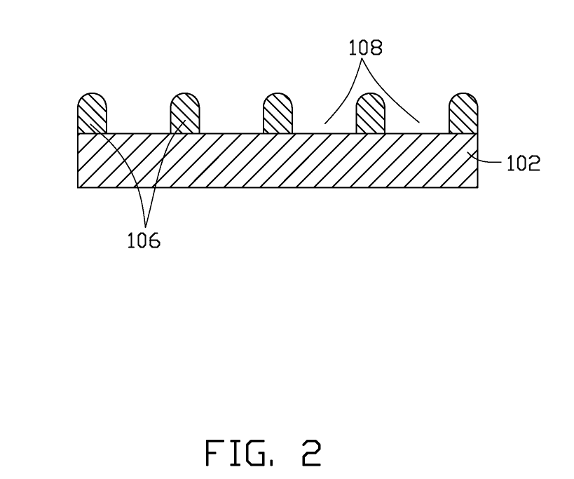

Referring to FIG. 1, a color filter 100 in accordance with a second embodiment is provided. The color filter 100 includes a substrate 102, a black matrix 106 formed on the substrate 102, and a plurality of color stripes 114 formed in spaces 108 (referring to FIG. 2) defined by the black matrix 106.

Preferably, the substrate 102 is a glass substrate. Preferably, a material of the black matrix 106 is a resin-based composition containing carbon black. The black matrix 106 defines a plurality of spaces 108 therein, and the spaces 108 are arranged in rows and columns on the color filter 100.

An ink of the color stripes 114 is similar with the ink in the first embodiment. The ink includes a solvent, a colorant, an initiator and/or dispersant, and a mixture of a polymerizable high-viscosity component and a polymerizable low-viscosity component polymerizable low-viscosity component. The polymerizable high-viscosity component includes high viscosity monomer or high viscosity oligomer. The polymerizable low-viscosity component includes low viscosity monomer or low viscosity oligomer.

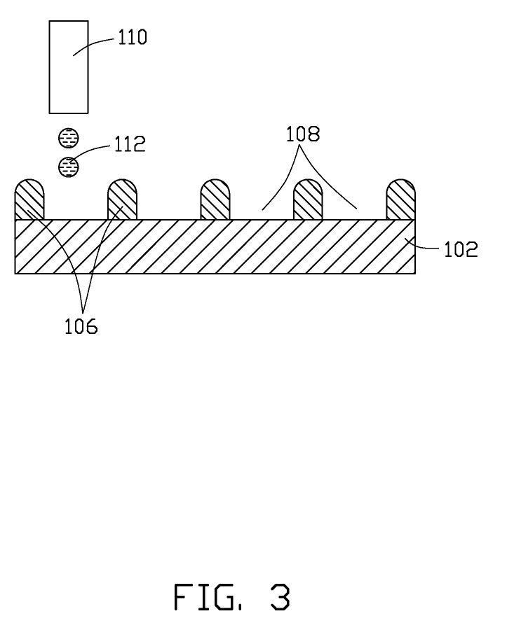

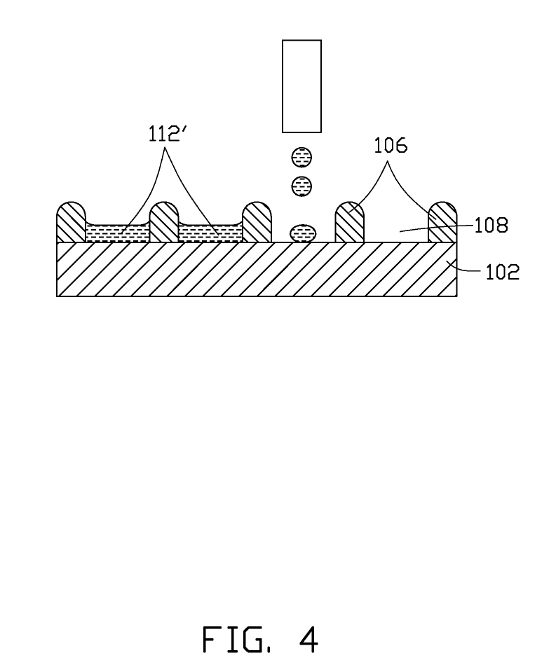

Referring to FIGS. 2 to 5, a method for manufacturing a color filter 100 is shown. The manufacturing method mainly includes the steps of: providing a transparent substrate 102; forming a black matrix 106 on the transparent substrate 102; ejecting required color ink 112 into spaces 108 defined by the black matrix 106 via an ink jet device to form color layer 112′; and solidifying the color layers 112′ to form color stripes 114.

In step 102, the black matrix 106 is formed by exposing a photoresist layer. The photoresist layer can be exposed via a photo mask and developed to form the patterned black matrix 106. The photoresist layer can be formed on the transparent substrate 102 using a wet spin coating method, a spin coating method, a slit coating method, or a slit and spin coating method.

In step 103, the ink includes a solvent, a colorant, an initiator and/or dispersant, and a mixture of a polymerizable high-viscosity component and a polymerizable low-viscosity component polymerizable low-viscosity component. The polymerizable high-viscosity component includes high viscosity monomer or high viscosity oligomer. The polymerizable low-viscosity component includes low viscosity monomer or low viscosity oligomer.

The viscosity of the high viscosity monomer or high viscosity oligomer at 25 degrees Centigrade is from 1000 CPS to 5000000 CPS, preferably, from 10000 CPS to 2000000 CPS.

The viscosity of the low viscosity monomer or low viscosity oligomer at 25 degrees Centigrade is not more than 999 CPS, preferably from 10 CPS to 500 CPS, more preferably from 10 CPS to 250 CPS.

The total amount of the polymerizable high-viscosity component in the mixture ranges from 50% to 99.9% by weight, preferably, from 50% to 80% by weight. The total amount of the polymerizable low-viscosity component in the mixture ranges from 0.1% to 50% by weight, preferably, from 20% to 50% by weight.

To enhance the smoothness of the color filter, the surface tension of the ink ranges preferably from 22.5 dyne/cm to 35 dyne/cm, more preferably from 25 dyne/cm to 30 dyne/cm.

In step 103, required color ink 112 are injected into the spaces 108 using an ink jet device, such as a thermal bubble ink jet printing apparatus or a piezoelectric ink jet printing apparatus.

In step 104, the ink layers 112′ can be solidified by a solidifying device (not shown), such as a heating device or a light-exposure device, to form color stripes 114. The light-exposure device can be an ultraviolet light source. A heating device and a vacuum-pumping device can also be used for solidifying the ink layers 112′ in the spaces 108 defined in the black matrix 106.

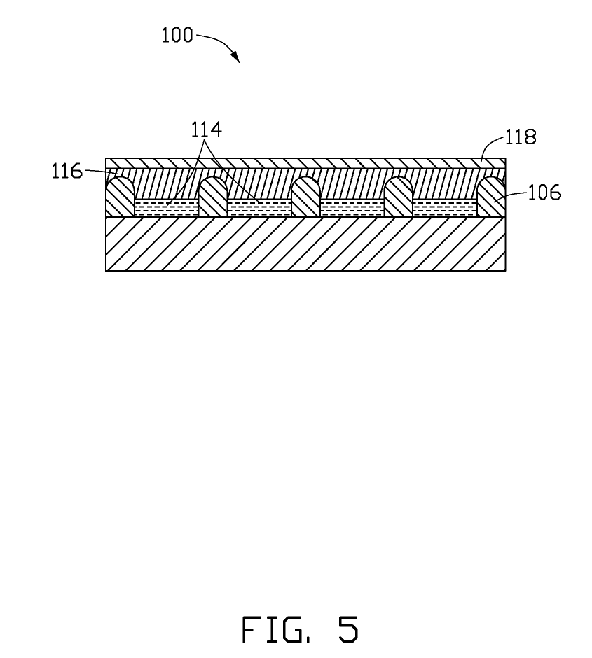

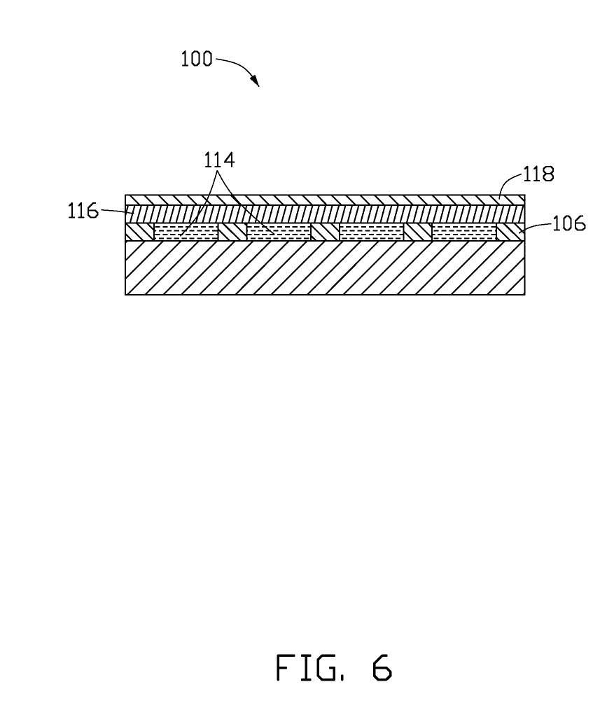

Referring to FIG. 5, an additional step following the step 104 for forming a protective layer 116 or an electrically conductive layer 118 may be performed. The portion of the black matrix higher than the color stripe 114 can be removed using a grinding method or an etching method before the protective layer 116 or the electrically conductive layer 118 is formed thereon. The protective layer 116 can be coated using a slit coating process or a spin coating process. The electrically conductive layer 118 can be deposited using a sputtering process. In addition, the protective layer 116 and the electrically conductive layer 118 can be formed on the black matrix 106 and the color stripe 114 sequentially.

Now, the present invention will be described in detail by providing examples.

A first example group includes a first comparative example 1 and examples 1-5 (see TABLE 1).

The ink of the first comparative example (C Eg. 1 for short) is comprised of 6 wt % C.I. modified Pigment Red 254, 2.4 wt % solsperse® 24000, 12 wt % bisphenol A epoxy diacrylate, 3 wt % IRGACURE® 907, 76.585 wt % tripropylene glycol methyl ether and dipropylene glycol methyl ether acetate, and 0.015 wt % siloxane surfactant.

The ink of the first example (Eg. 1 for short) is comprised of 6 wt % C.I. modified Pigment Red 254, 2.4 wt % solsperse® 24000, 11 wt % bisphenol A epoxy diacrylate, 3 wt % IRGACURE® 907, 76.585 wt % tripropylene glycol methyl ether and dipropylene glycol methyl ether acetate, 0.015 wt % siloxane surfactant, and 1 wt % ethoxylated (3) bisphenol A diacrylate monomer.

The ink of the second example (Eg. 2 for short) is comprised of 6 wt % C.I. modified Pigment Red 254, 2.4 wt % solsperse® 24000, 9 wt % bisphenol A epoxy diacrylate, 3 wt % IRGACURE® 907, 76.585 wt % tripropylene glycol methyl ether and dipropylene glycol methyl ether acetate, 0.015 wt % siloxane surfactant, and 3 wt % ethoxylated (3) bisphenol A diacrylate monomer.

The ink of the third example (Eg. 3 for short) is comprised of 6 wt % C.I. modified Pigment Red 254, 2.4 wt % solsperse® 24000, 8 wt % bisphenol A epoxy diacrylate, 3 wt % IRGACURE® 907, 76.585 wt % tripropylene glycol methyl ether and dipropylene glycol methyl ether acetate, 0.015 wt % siloxane surfactant, and 4 wt % ethoxylated (3) bisphenol A diacrylate monomer.

The ink of the forth example (Eg. 4 for short) is comprised of 6 wt % C.I. modified Pigment Red 254, 2.4 wt % solsperse® 24000, 6 wt % bisphenol A epoxy diacrylate, 3 wt % IRGACURE® 907, 76.585 wt % tripropylene glycol methyl ether and dipropylene glycol methyl ether acetate, 0.015 wt % siloxane surfactant, and 6 wt % ethoxylated (3) bisphenol A diacrylate monomer.

The ink of the fifth example (Eg. 5 for short) is comprised of 6 wt % C.I. modified Pigment Red 254, 2.4 wt % solsperse® 24000, 4 wt % bisphenol A epoxy diacrylate, 3 wt % IRGACURE® 907, 76.585 wt % tripropylene glycol methyl ether and dipropylene glycol methyl ether acetate, 0.015 wt % siloxane surfactant, and 8 wt % ethoxylated (3) bisphenol A diacrylate monomer.

TABLE 1

| Ink | C Eg. 1 | Eg. 1 | Eg. 2 | Eg. 3 | Eg. 4 | Eg. 5 |
|---|---|---|---|---|---|---|
| colorant (wt %) | 6 | 6 | 6 | 6 | 6 | 6 |
| dispersant (wt %) | 2.4 | 2.4 | 2.4 | 2.4 | 2.4 | 2.4 |
| polymerizable low-viscosity | 0 | 1 | 3 | 4 | 6 | 8 |
| component (wt %) | | | | | | |
| polymerizable high-viscosity | 12 | 11 | 9 | 8 | 6 | 4 |
| component (wt %) | | | | | | |
| initiator (wt %) | 3 | 3 | 3 | 3 | 3 | 3 |
| resin (wt %) | 0 | 0 | 0 | 0 | 0 | 0 |
| solvent (wt %) | 76.585 | 76.585 | 76.585 | 76.585 | 76.585 | 76.585 |
| surfactant (wt %) | 0.015 | 0.015 | 0.015 | 0.015 | 0.015 | 0.015 |
| smoothness Ra (nm) | 55 | 28 | 19 | 17 | 16 | 15 |
| color change delta Ea, b | <3 | <3 | <3 | <3 | <3 | 4 |

The result of comparison between the comparative example 1 and the examples 1-5 shows that the total amount of the polymerizable low-viscosity component in the ink is higher, the color strips is more smooth, but the color change after curing is too big(delta Ea, b>3).

A second example group includes a second comparative example 2 and examples 2-9 (see TABLE 2).

The ink of the second comparative example (C Eg. 2 for short) is comprised of 8 wt % C.I. Pigment Green 36, 3.2 wt % solsperse® 24000, 8 wt % dipentaerythritol hexaarylate, 2 wt % IRGACURE® 184, 4 wt % polyacrylate resin, 74.78 wt % ethylene glycol monobutyl ether acetate, and 0.02 wt % fluorosurfactant.

The ink of the sixth example (Eg. 6 for short) is comprised of 8 wt % C.I. Pigment Green 36, 3.2 wt % solsperse® 24000, 6 wt % bisphenol A epoxy diacrylate, 2 wt % IRGACURE® 184, 4 wt % polyacrylate resin, 74.78 wt % ethylene glycol monobutyl ether acetate, 0.02 wt % fluorosurfactant, and 2 wt % pentaerythritol tetraacrylate.

The ink of the seventh example (Eg. 7 for short) is comprised of 8 wt % C.I. Pigment Green 36, 3.2 wt % solsperse® 24000, 4 wt % dipentaerythritol hexaarylate, 2 wt % IRGACURE® 184, 4 wt % polyacrylate resin, 74.78 wt % ethylene glycol monobutyl ether acetate, 0.02 wt % fluorosurfactant, and 4 wt % pentaerythritol tetraacrylate.

The ink of the eighth example (Eg. 8 for short) is comprised of 8 wt % C.I. Pigment Green 36, 3.2 wt % solsperse® 24000, 2 wt % dipentaerythritol hexaarylate, 2 wt % IRGACURE® 184, 4 wt % polyacrylate resin, 74.78 wt % ethylene glycol monobutyl ether acetate, 0.02 wt % fluorosurfactant, and 6 wt % pentaerythritol tetraacrylate.

The ink of the ninth example (Eg. 9 for short) is comprised of 8 wt % C.I. Pigment Green 36, 3.2 wt % solsperse® 24000, 2 wt % IRGACURE® 184, 4 wt % polyacrylate resin, 74.78 wt % ethylene glycol monobutyl ether acetate, 0.02 wt % fluorosurfactant, and 8 wt % pentaerythritol tetraacrylate.

The ink of the fifth example (Eg. 5 for short) is comprised of 8 wt % C.I. Pigment Green 36, 3.2 wt % solsperse® 24000, 4 wt % dipentaerythritol hexaarylate, 2 wt % IRGACURE® 184, 4 wt % polyacrylate resin, 74.78 wt % ethylene glycol monobutyl ether acetate, 0.02 wt % fluorosurfactant, and 8 wt % ethoxylated (3) bisphenol A diacrylate monomer.

TABLE 2

| Ink | C Eg. 2 | Eg. 6 | Eg. 7 | Eg. 8 | Eg. 9 |
|---|---|---|---|---|---|
| colorant (wt %) | 8 | 8 | 8 | 8 | 8 |
| dispersant (wt %) | 3.2 | 3.2 | 3.2 | 3.2 | 3.2 |
| polymerizable low-viscosity | 0 | 2 | 4 | 6 | 8 |
| component (wt %) | | | | | |
| polymerizable high-viscosity | 8 | 6 | 4 | 2 | 0 |
| component (wt %) | | | | | |
| initiator (wt %) | 2 | 2 | 2 | 2 | 2 |
| resin (wt %) | 4 | 4 | 4 | 4 | 4 |
| solvent (wt %) | 74.78 | 74.78 | 74.78 | 74.78 | 74.78 |
| surfactant (wt %) | 0.02 | 0.02 | 0.02 | 0.02 | 0.02 |
| smoothness Ra (nm) | 54 | 18 | 16 | 13 | 12 |
| color change delta Ea, b | <3 | <3 | <3 | 3.2 | 4 |

The result of comparison between the comparative example 2 and the examples 6-9 is similar with that of the first example group. The resin added to the ink does not influence the result.

A third example group includes examples 10-13 (see TABLE 3).

The ink of the tenth example (Eg. 10 for short) is comprised of 6 wt % C.I. Pigment Blue 15:6 and C.I. Pigment Violet 23, 3 wt % solsperse® 24000, 6 wt % aliphatic urethane diacrylate oligomer, 2 wt % ditert-butyl peroxide, 4 wt % methacrylate/acrylonitrile-methyl phenyl methacryate copolymer, 77 wt % a mixture of ethylene glycol phenyl ether, tripropyleneglycol methyl ether and tripropyleneglycol methyl ether, and 2 wt % low viscosity acrylat ester oligomer.

The ink of the eleventh example (Eg. 11 for short) is comprised of 6 wt % C.I. Pigment Blue 15:6 and C.I. Pigment Violet 23, 3 wt % solsperse® 24000, 6 wt % aliphatic urethane diacrylate oligomer, 2 wt % ditert-butyl peroxide, 4 wt % methacrylate/acrylonitrile-methyl phenyl methacryate copolymer, 76.99 wt % a mixture of ethylene glycol phenyl ether, tripropyleneglycol methyl ether and tripropyleneglycol methyl ether, 0.010 wt % fluorosurfactant, and 2 wt % low viscosity acrylat ester oligomer.

The ink of the twelfth example (Eg. 12 for short) is comprised of 6 wt % C.I. Pigment Blue 15:6 and C.I. Pigment Violet 23, 3 wt % solsperse® 24000, 6 wt % aliphatic urethane diacrylate oligomer, 2 wt % ditert-butyl peroxide, 4 wt % methacrylate/acrylonitrile-methyl phenyl methacryate copolymer, 76.975 wt % a mixture of ethylene glycol phenyl ether, tripropyleneglycol methyl ether and tripropyleneglycol methyl ether, 0.025 wt % fluorosurfactant, and 2 wt % low viscosity acrylat ester oligomer.

The ink of the thirteenth example (Eg. 13 for short) is comprised of 6 wt % C.I. Pigment Blue 15:6 and C.I. Pigment Violet 23, 3 wt % solsperse® 24000, 6 wt % aliphatic urethane diacrylate oligomer, 2 wt % ditert-butyl peroxide, 4 wt % methacrylate/acrylonitrile-methyl phenyl methacryate copolymer, 76.95 wt % a mixture of ethylene glycol phenyl ether, tripropyleneglycol methyl ether and tripropyleneglycol methyl ether, 0.050 wt % fluorosurfactant, and 2 wt % low viscosity acrylat ester oligomer.

TABLE 3

| Ink | Eg. 10 | Eg. 11 | Eg. 12 | Eg. 13 |
|---|---|---|---|---|
| colorant (wt %) | 6 | 6 | 6 | 6 |
| dispersant (wt %) | 3 | 3 | 3 | 3 |
| polymerizable low-viscosity | 2 | 2 | 2 | 2 |
| component (wt %) | | | | |
| polymerizable high-viscosity | 6 | 6 | 6 | 6 |
| component (wt %) | | | | |
| initiator (wt %) | 2 | 2 | 2 | 2 |
| resin (wt %) | 4 | 4 | 4 | 4 |
| solvent (wt %) | 77 | 76.99 | 76.975 | 76.95 |
| surfactant (wt %) | 0 | 0.010 | 0.025 | 0.050 |
| surface tension (dyne/cm) | 38 | 34 | 29 | 25 |
| smoothness Ra (nm) | 35 | 18 | 14 | 13 |

The result of comparison between the examples 10-13 shows that the smoothness of the color strips can be enhanced by using ink with surface tension in a range from 22.5 dyne/cm to 35 dyne/cm.

A forth example group includes examples 14-18 (see TABLE 4 and TABLE 5).

The ink of the fourteenth example (Eg. 14 for short) is comprised of 6 wt % C.I. Pigment Red 254 and C.I. Pigment Yellow 139, 3 wt % solsperse® 24000 and amine modified polyacrylate, 4 wt % high viscosity diacrylate oligomer CN133, 2 wt % tris(trichloromethyl)-1,3,5-triazine, 4 wt % methacrylate/n-butyl methacrylate, 77 wt % a mixture of Dipropylene glycol monomethyl ether and propylene glycol methyl ether acetate, and 4 wt % low viscosity tridecyl polymathacrylate.

The ink of the fifteenth example (Eg. 15 for short) is comprised of 6 wt % C.I. Pigment Red 254 and C.I. Pigment Yellow 139, 3 wt % solsperse® 24000 and amine modified polyacrylate, 4 wt % high viscosity diacrylate oligomer CN133, 2 wt % tris(trichloromethyl)-1,3,5-triazine, 4 wt % methacrylate/n-butyl methacrylate, 77 wt % a mixture of Dipropylene glycol monomethyl ether and propylene glycol methyl ether acetate, and 4 wt % low viscosity polyethylene glycol (400) diacrylate.

The ink of the sixteenth example (Eg. 16 for short) is comprised of 6 wt % C.I. Pigment Red 254 and C.I. Pigment Yellow 139, 3 wt % solsperse® 24000 and amine modified polyacrylate, 4 wt % high vicosity diacrylate oligomer CN133, 2 wt % tris(trichloromethyl)-1,3,5-triazine, 4 wt % methacrylate/n-butyl methacrylate, 77 wt % a mixture of Dipropylene glycol monomethyl ether and propylene glycol methyl ether acetate, and 4 wt % low viscosity 1,6-hexylene glycol dimethacrylate.

The ink of the seventeenth example (Eg. 17 for short) is comprised of 6 wt % C.I. Pigment Red 254 and C.I. Pigment Yellow 139, 3 wt % solsperse® 24000 and amine modified polyacrylate, 4 wt % high vicosity diacrylate oligomer CN133, 2 wt % tris(trichloromethyl)-1,3,5-triazine, 4 wt % methacrylate/n-butyl methacrylate, 77 wt % a mixture of Dipropylene glycol monomethyl ether and propylene glycol methyl ether acetate, and 4 wt % low viscosity ethoxylated (20) trihydroxymethylpropyl triacrylate.

The ink of the eighteenth example (Eg. 18 for short) is comprised of 6 wt % C.I. Pigment Red 254 and C.I. Pigment Yellow 139, 3 wt % solsperse® 24000 and amine modified polyacrylate, 4 wt % high vicosity diacrylate oligomer CN133, 2 wt % tris(trichloromethyl)-1,3,5-triazine, 4 wt % methacrylate/n-butyl methacrylate, 77 wt % a mixture of Dipropylene glycol monomethyl ether and propylene glycol methyl ether acetate, and 4 wt % low viscosity pentaerythritol tetraacrylate.

TABLE 4

| | Eg. 14 | Eg. 15 | Eg. 16 |
|---|---|---|---|
| colorant (wt %) | 6 | 6 | 6 |
| dispersant (wt %) | 3 | 3 | 3 |
| polymerizable | 4 | 4 | 4 |
| low-viscosity | | | |
| component (wt %) | | | |
| polymerizable | tridecyl | polyethylene | 1,6-hexylene |
| low-viscosity | polymathacrylate | glycol (400) | glycol |
| component | | diacrylate | dimethacrylate |
| functionality | 1 | 2 | 2 |
| glass transition | −40 | 3 | 30 |
| point (degrees | | | |
| Centigrade) | | | |
| polymerizable | 4 | 4 | 4 |
| high-viscosity | | | |
| component (wt %) | | | |
| initiator (wt %) | 2 | 2 | 2 |
| resin (wt %) | 4 | 4 | 4 |
| solvent (wt %) | 77 | 77 | 77 |
| delta Ea, b | 4.2 | 2.8 | 2.1 |

TABLE 5

| | Eg. 17 | Eg. 18 |
|---|---|---|
| colorant (wt %) | 6 | 6 |
| dispersant (wt %) | 3 | 3 |
| polymerizable low-viscosity | 4 | 4 |
| component (wt %) | | |
| polymerizable low-viscosity | ethoxylated (20) | pentaerythritol |
| component | trihydroxymethylpropyl | tetraacrylate |
| | triacrylate | |
| functionality | 3 | 4 |
| glass transition point (degrees | 38 | 103 |
| Centigrade) | | |
| polymerizable high-viscosity | 4 | 4 |
| component (wt %) | | |
| initiator (wt %) | 2 | 2 |
| resin (wt %) | 4 | 4 |
| solvent (wt %) | 77 | 77 |
| delta Ea, b | 1.9 | 1.6 |

The result of comparison between the examples 14-18 shows that the glass transition point of the polymerizable low-viscosity component is higher, color change is smaller.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. An ink for making a color filter, comprising:
a solvent,
a colorant,
an initiator or a dispersant, and
a mixture of a polymerizable high-viscosity component and a polymerizable low-viscosity component.

2. The ink as claimed in claim 1, wherein the polymerizable high-viscosity component includes at least one of high viscosity monomer and high viscosity oligomer.

3. The ink as claimed in claim 1, wherein the polymerizable low-viscosity component includes at least one of low viscosity monomer and low viscosity oligomer.

4. The ink as claimed in claim 2, wherein a viscosity of the high viscosity monomer or the high viscosity oligomer at 25 degrees Centigrade is in the range from 1000 CPS to 5000000 CPS.

5. The ink as claimed in claim 2, wherein a viscosity of the high viscosity monomer or the high viscosity oligomer at 25 degrees Centigrade is in the range from 10000 CPS to 2000000 CPS.

6. The ink as claimed in claim 3, wherein a viscosity of the low viscosity monomer or the low viscosity oligomer at 25 degrees Centigrade is not more than 999 CPS.

7. The ink as claimed in claim 3, wherein a viscosity of the low viscosity monomer or the low viscosity oligomer at 25 degrees Centigrade is in the range from 10 CPS to 500 CPS.

8. The ink as claimed in claim 1, wherein molecular weight and chemical construction of the polymerizable high-viscosity component are different with those of the polymerizable low-viscosity component.

9. The ink as claimed in claim 1, wherein a total ratio by weight of the polymerizable high-viscosity component in all of the polymerizable component mixture ranges from 50% to 99.9%, and a total ratio by weight of the polymerizable low-viscosity component all of in the polymerizable component mixture ranges from 0.1% to 50%.

10. The ink as claimed in claim 1, wherein a total ratio by weight of the polymerizable high-viscosity component in all of the polymerizable component mixture ranges from 50% to 80%, and a total amount by weight of the polymerizable low-viscosity component in all of the polymerizable component mixture ranges from 20% to 50%.

11. The ink as claimed in claim 1, wherein a surface tension of the ink ranges from 22.5 dyne/cm to 35 dyne/cm.

12. The ink as claimed in claim 2, wherein the high viscosity monomer or high viscosity oligomer is selected from the group consisting of epoxy acrylate oligomers with at least two functionalities, urethane acrylate oligomers with at least two functionalities, polyester acrylate oligomers with at least two functionalities, acrylate oligomers with at least two functionalities, diacrylate monomers with ethoxylated bisphenol A group, acrylate monomers with at least five functionalities, and their derivatives.

13. The ink as claimed in claim 2, wherein the high viscosity oligomer is selected from the group consisting of bisphenol A epoxy diacrylate, bisphenol A epoxy dimethacrylate, amine modified bisphenol A epoxy acrylate, fatty acid modified bisphenol A epoxy acrylate, novolac epoxy acrylate, aromatic urethane diacrylat, aromatic urethane triacrylate, aromatic urethane hexaacrylate, aliphatic urethane diacrylate, aliphatic urethane triacrylate, aliphatic urethane hexaacrylate, polyester diacrylate, polyester tetraacrylate, polyester hexaacrylate, fatty acid modified polyester hexaacrylate, chlorinated polyester acrylate, amine modified polyester acrylate, aliphatic diacrylate and acrylate with a vitrification point of above 20 degrees Centigrade.

14. The ink as claimed in claim 2, wherein the high viscosity monomer is selected from the group consisting of ethoxylated (2) bisphenol A diacrylate, ethoxylated (3) bisphenol A diacrylate, ethoxylated (2) bisphenol A dimethacrylate, dipentaerythritol pentaacrylate and dipentaerythritol hexaarylate.

15. The ink as claimed in claim 3, wherein the low viscosity monomer is selected from the group consisting of acrylate monomer with 2 functionalities, acrylate monomer with 3 functionalities, methacrylate monomer with 3 functionalities, and acrylate monomer with 4 functionalities.

16. The ink as claimed in claim 3, wherein the low viscosity monomer is selected from the group consisting of diethylene glycol diacrylate, triethylene glycol diacrylate, polyethylene glycol (200) diacrylate, polyethylene glycol (400) diacrylate, polyethylene glycol (600) diacrylate, 1,3-butylene glycol diacrylate, 1,4-butylene glycol diacrylate, 1,6-hexylene glycol diacrylate, diethylene glycol diacrylate, ethoxylated (3) bisphenol A diacrylate, ethoxylated (10) bisphenol A diacrylate, ethylene glycol dimethacrylate, diethylene glycol dimethacrylate, triethylene glycol dimethacrylate, polyethylene glycol (200) dimethacrylate, polyethylene glycol (400) dimethacrylate, polyethylene glycol (600) dimethacrylate, 1,3-butylene glycol dimethacrylate, 1,4-butylene glycol dimethacrylate, 1,6-hexylene glycol dimethacrylate, ethoxylated (6) bisphenol A dimethacrylate, ethoxylated (8) bisphenol A dimethacrylate, ethoxylated (10) bisphenol A dimethacrylate, new pentanediol dimethacrylate, trihydroxymethylpropyl triacrylate, ethoxylated (3) trihydroxymethylpropyl triacrylate, ethoxylated (20) trihydroxymethylpropyl triacrylate, pentaoxylated (3) trihydroxymethylpropyl triacrylate, pentaoxylated (6) trihydroxymethylpropyl triacrylate, pentaerythritol triacrylate and pentaerythritol tetraacrylate.

17. A color filter, comprising
a substrate;
a black matrix formed on the substrate, the black matrix defining a plurality of spaces therein, a plurality of the color stripes formed in the spaces, the color stripes having a composition comprising:
a solvent,
a colorant,
an initiator or a dispersant, and
a mixture of a polymerizable high-viscosity component and a polymerizable low-viscosity component polymerizable low-viscosity component.

18. The color filter as claimed in claim 17, wherein the polymerizable high-viscosity component includes at least one of high viscosity monomer and high viscosity oligomer.

19. The color filter as claimed in claim 17, wherein the polymerizable low-viscosity component includes at least one of low viscosity monomer and low viscosity oligomer.

20. The color filter as claimed in claim 18, wherein a viscosity of the high viscosity monomer or the high viscosity oligomer at 25 degrees Centigrade is in the range from 1000 CPS to 5000000 CPS.

21. The color filter as claimed in claim 18, wherein a viscosity of the high viscosity monomer or the high viscosity oligomer at 25 degrees Centigrade is in the range from 10000 CPS to 2000000 CPS.

22. The color filter as claimed in claim 19, wherein a viscosity of the low viscosity monomer or the low viscosity oligomer at 25 degrees Centigrade is not more than 999 CPS.

23. The color filter as claimed in claim 19, wherein a viscosity of the low viscosity monomer or the low viscosity oligomer at 25 degrees Centigrade is from 10 CPS to 500 CPS.

24. The color filter as claimed in claim 17, wherein molecular weight and chemical construction of the polymerizable high-viscosity component are different with those of the polymerizable low-viscosity component.

25. The color filter as claimed in claim 17, wherein a total ratio by weight of the polymerizable high-viscosity component in all of the polymerizable component mixture ranges from 50% to 99.9%, and a total ratio by weight of the polymerizable low-viscosity component in all of the polymerizable component mixture ranges from 0.1% to 50%.

26. The color filter as claimed in claim 17, wherein a total ratio by weight of the polymerizable high-viscosity component in all of the polymerizable component mixture ranges from 50% to 80%, and a total ratio by weight of the polymerizable low-viscosity component in all of the polymerizable component mixture ranges from 20% to 50%.

27. The color filter as claimed in claim 17, wherein an surface tension of the ink ranges from 22.5 dyne/cm to 35 dyne/cm.
